(19) United States
(12) Patent Application Publication
(10) Pub. No.: US 2010/0097799 A1
(43) Pub. Date: Apr. 22, 2010

(54) LED LIGHTING FLOOD LAMP HAVING DOUBLE HEAT DISSIPATION PLATE STRUCTURE USING NANO SPREADERS

(75) Inventor: Sung Ho SHIN, Gwayngmyeong-si (KR)

Correspondence Address: SEED INTELLECTUAL PROPERTY LAW GROUP PLLC, 701 FIFTH AVE, SUITE 5400, SEATTLE, WA, 98104, US

(73) Assignee: Hyundai Telecommunication Co., Ltd., Seoul (KR)

(21) Appl. No.: 12/371,493

(22) Filed: Feb. 13, 2009

(30) Foreign Application Priority Data
Oct. 17, 2008 (KR) 10-2008-0102234

(51) Int. Cl. F21V 1/00

(52) U.S. Cl. 362/235

(57) ABSTRACT

An LED lighting flood lamp having a double heat dissipation plate structure using nano spreaders are provided, in which the double heat dissipation plate structure is formed by installing the nano spreaders having high heat diffusion inside the lamp and forming heat dissipation plates on upper and lower parts of the nano spreaders, and heat dissipation pins are arranged in zigzag on the upper part of the upper heat dissipation plate, so that the heat dissipation efficiency is maximized, and the lamp has a slim external appearance without being limited in installation space. The LED lighting flood lamp includes LEDs, an LED mounting substrate on which the LEDs are mounted, nano spreaders mounted on an upper side of the LED mounting substrate, an upper heat dissipation plate fixed to an upper side of the nano spreaders and having a plurality of heat dissipation pins formed on an upper surface thereof, a lower heat dissipation plate fixed to a lower part of the LED mounting substrate, and a diffusion lens plate fixed to a lower part of the lower heat dissipation plate.

### CROSS-REFERENCE TO RELATED APPLICATION

This application is based on and claims priority from Korean Patent Application No. 10-2008-102234, filed on Oct. 17, 2008 in the Korean Intellectual Property Office, the disclosure of which is incorporated herein in its entirety by reference.

### BACKGROUND OF THE INVENTION

1. Field of the Invention

The present invention relates to an LED lighting flood lamp, and more particularly, to an LED lighting flood lamp having a double heat dissipation plate structure using nano spreaders, which can maximize heat dissipation efficiency by using the surface area in all directions as a heat dissipation plate in comparison to other heat dissipation structures having the same volume, maximize heat efficiency by reducing heat resistance in the heat dissipation plate through a direct exposure of inner heat to an outdoor environment, and prevent flood and dust by its slim external appearance.

2. Description of the Prior Art

In general, various kinds of flood lamps including vehicle head lamps, rear combination lamps, street lamps, and the like, use a bulb as their light source.

However, since the conventional bulb has a short life span and a lowered anti-shock performance, there is a recent trend that a high-luminance LED (Light Emitting Diode) having a long life span and an excellent anti-shock performance is used as a light source.

Particularly, the high-luminance LED can be used as a light source of various kinds of flood lamps including vehicle head lamps, rear combination lamps, interior lamps, street lamps, and the like, and its application range is extensive.

The high-luminance LED emits superheat when it is turned on, and due to this superheat emission, there are difficulties in designing and applying the LED as a light source.

FIG. 9 is a view illustrating an example of a heat dissipation structure of a conventional LED lighting flood lamp.

According to the conventional LED lighting flood lamp as illustrated in FIG. 9, a cover 13, which is positioned in the rear of a substrate 11 having a plurality of LEDs 2 attached thereto, is formed of a metallic material, and/or a plurality of holes 13a for heat dissipation and air circulation are formed on the cover 13 to dissipate heat generated from the LEDs 2.

However, the conventional LED lighting flood lamp structure has the problems that its heat dissipation is limited and the amount of heat generated from the LEDs is larger than the amount of heat dissipation, so that the temperature of the LED lighting flood lamp is continuously heightened. Accordingly, in designing the LED lighting flood lamp, it is required to select expensive flame-retardant or inflammable materials and to use resin or metallic materials that are not thermally deformed or contracted even at high temperatures.

Also, if the heat dissipation efficiency is low, the life span of the LEDs is shortened.

On the other hand, FIG. 10 is a sectional view illustrating another example of a heat dissipation structure of a conventional LED lighting flood lamp.

The heat dissipation structure of the conventional LED lighting flood lamp as illustrated in FIG. 10 includes an aluminum substrate 50, heat pipes 20, a heat dissipation cover 30, and heat dissipation pins 40, and a plurality of LEDs 60 for emitting high-luminance light are mounted on the aluminum substrate 50.

Lower ends of the heat pipes 20 are mounted on the aluminum substrate 50, and heat generated from the LEDs 60 is transferred to the heat dissipation pins 40 to dissipate the transferred heat.

As the heat dissipation is primarily performed by the heat dissipation pins 40, air inside the heat dissipation cover 30 is heated by the dissipated heat, and the heat of the heated air is transferred to the heat dissipation cover 30. The heat dissipation cover 30 is in contact with external air, and the heat dissipation is secondarily performed between the heat dissipation cover 30 and the external air.

According to the heat dissipation structure of the conventional LED lighting flood lamp as described above, since the heat, which is generated from the LEDs 60 and is transferred through the heat pipes 20, is primarily dissipated through the heat dissipation pins 40 to heat the air in the heat dissipation cover 30 and then the heat of the heated air is transferred to the heat dissipation cover 30, the heat transfer speed is lowered, and the actual heat dissipation effect by the heat dissipation pins 40 becomes lowered. Further, since the secondary heat dissipation is performed only by the direct contact between the heat dissipation cover 30 and the external air, the heat dissipation effect is not so high.

### SUMMARY OF THE INVENTION

Accordingly, the present invention has been made to solve the above-mentioned problems occurring in the prior art while advantages achieved by the prior art are maintained intact.

One object of the present invention is to provide an LED lighting flood lamp having a double heat dissipation plate structure using nano spreaders, which can prevent flood and dust by its slim external appearance, and maximize the heat dissipation efficiency and usability by providing the double heat dissipation plate structure using the nano spreaders.

In order to accomplish this object, there is provided an LED lighting flood lamp having a double heat dissipation plate structure using nano spreaders, according to an embodiment of the present invention, which includes LEDs; an LED mounting substrate on which the LEDs are mounted; nano spreaders mounted on an upper side of the LED mounting substrate; an upper heat dissipation plate fixed to an upper side of the nano spreaders and having a plurality of heat dissipation pins formed on an upper surface thereof; a lower heat dissipation plate fixed to a lower part of the LED mounting substrate; and a diffusion lens plate fixed to a lower part of the lower heat dissipation plate.

The LED lighting flood lamp according to an embodiment of the present invention may further include sealing members inserted between the upper heat dissipation plate and the lower heat dissipation plate and between the lower heat dissipation plate and the diffusion lens plate, respectively, to improve sealing performance.

The nano spreaders may be in the shape of a straight board, and may be arranged at predetermined intervals in a length direction of the upper heat dissipation plate.

The upper heat dissipation plate may include an upper heat dissipation plate housing having a center part descending downward and both side parts projecting upward, and the heat dissipation pins arranged at predetermined intervals on an upper surface of the center part of the upper heat dissipation plate housing.

The upper heat dissipation plate housing may include a center part having a height lower than that of adjacent parts, and side parts positioned on both sides of the center part, projecting upward for a specified length, and having a reverse U-shaped (“n”) cross section.

The lower heat dissipation plate may include a center part composed of a flat plate member having a specified thickness, on which through-holes are formed at predetermined intervals, and both side parts projecting upward in comparison to the center part and having auxiliary heat dissipation plates formed thereon to dissipate heat in a side direction.

The lens diffusion plate may include a lower surface formed as a flat surface, and an upper surface on which projection members that are in contact with the LEDs are formed to match the arrangement state of the LEDs.

It is preferable that the heat dissipation pins are formed in a pin shape, and are arranged in zigzag to change air flow passing between the heat dissipation pins.

The upper heat dissipation plate may have connection members mounted on an upper side thereof to assemble a plurality of LED lighting flood lamps into one, so that an LED lighting flood lamp having much larger capacity can be used.

It is also preferable that wire insertion grooves for inserting wires therein are formed on lower portions of the side parts of an LED lighting flood lamp to fasten the LED lighting flood lamp to the wires, and separate wire fixing means are provided to fix/release the LED lighting flood lamp to/from the wires.

According to the LED lighting flood lamp having a double heat dissipation plate structure using nano spreaders according to the present invention, the whole surface area in upper, lower, left, and right directions is used as a heat dissipation plate in comparison to other heat dissipation structures having the same volume, and the inner heat is directly exposed to an outdoor environment to dissipate the heat, so that the heat dissipation efficiency can be maximized.

Also, since the LED lighting flood lamp according to the present invention has a slim external appearance with good design, it is not restricted by installation space and thus can be used not only indoors but also outdoors.

In addition, since the heat dissipation pins are arranged in zigzag on the upper heat dissipation plate, air can easily flow through the heat dissipation pins, and thus the sticking of dust or foreign substances to the heat dissipation pins is greatly reduced. Particularly, in the case of outdoor products, the foreign substances sticking to the heat dissipation plate can be easily removed through natural washing.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of an LED lighting flood lamp using nano spreaders according to an embodiment of the present invention;

FIG. 2 is an exploded perspective view of the LED lighting flood lamp illustrated in FIG. 1;

FIGS. 3A and 3B are perspective views of an LED lighting flood lamp using nano spreaders, seen from the upper part and the lower part thereof, according to an embodiment of the present invention;

FIG. 3C is a view illustrating the LED lighting flood lamp of FIG. 3B that is used indoors;

FIG. 4 is a sectional view taken along line A-A in FIG. 3A;

FIGS. 5A and 5B are views illustrating an upper heat dissipation plate on which heat dissipation pins are formed according to an embodiment of the present invention;

FIGS. 6 to 8A and 8B are views illustrating the use state of an LED lighting flood lamp having a double heat dissipation plate structure using nano spreaders according to an embodiment of the present invention; and

FIGS. 9 and 10 are views illustrating examples of a conventional LED lighting flood lamp.

### DETAILED DESCRIPTION OF THE PREFERRED EMBODIMENTS

Hereinafter, an LED lighting flood lamp having a double heat dissipation plate structure using nano spreaders according to the preferred embodiment of the present invention will be described in detail with reference to the accompanying drawings.

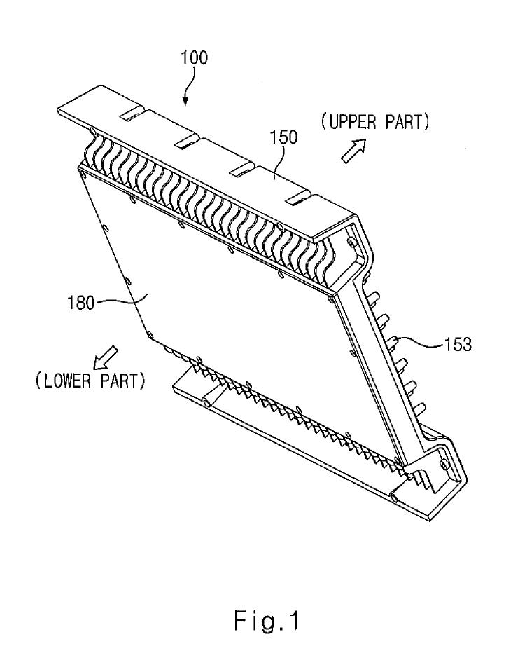

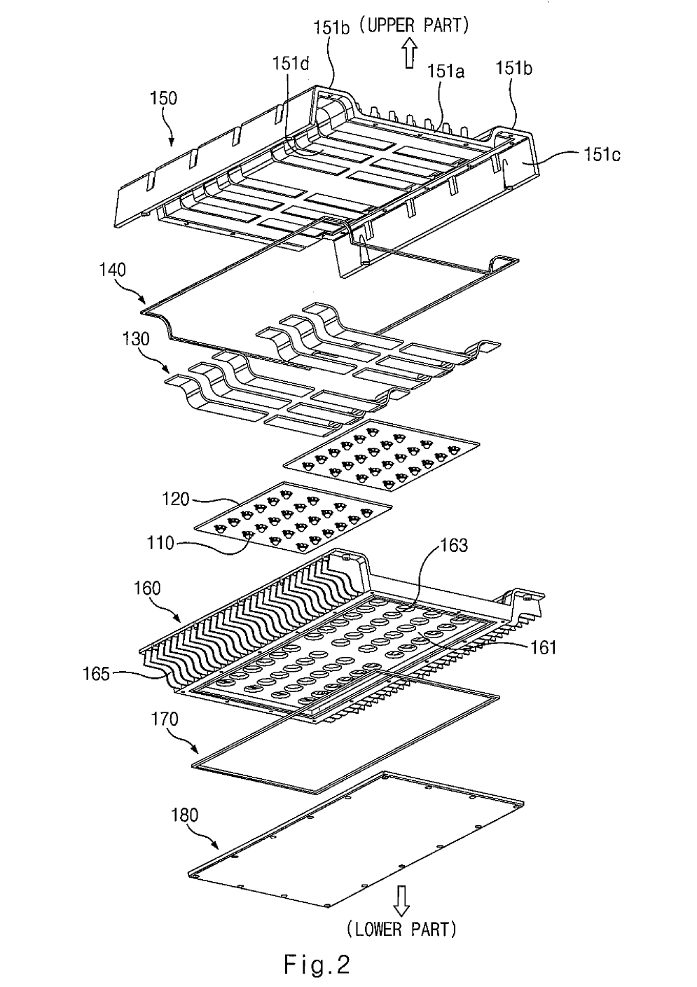

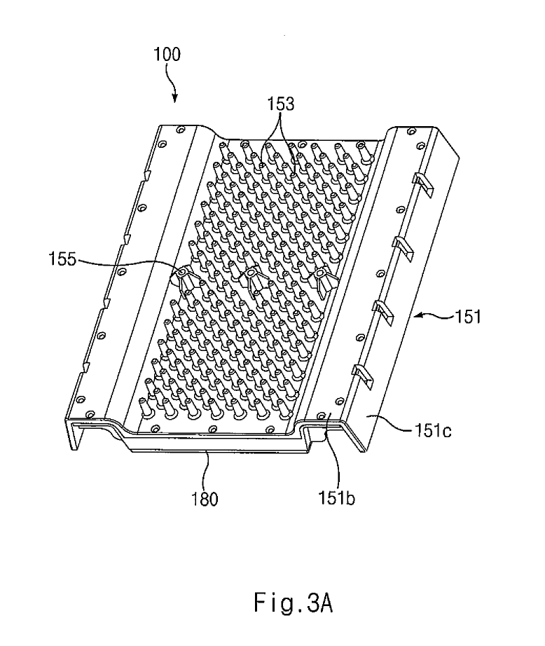

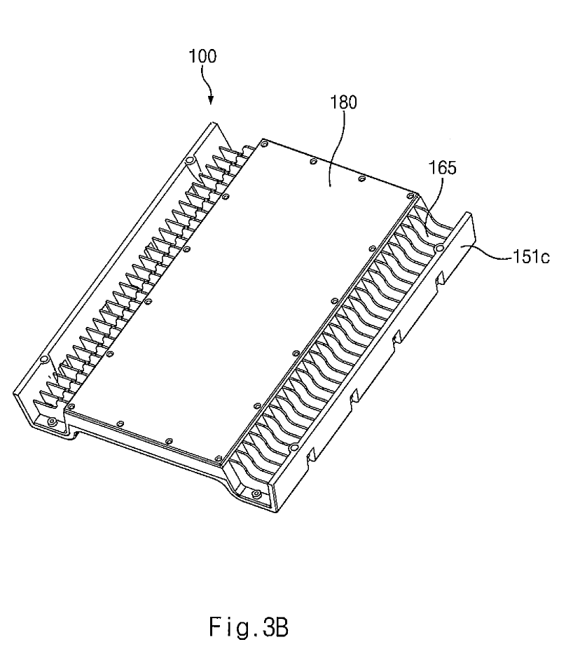

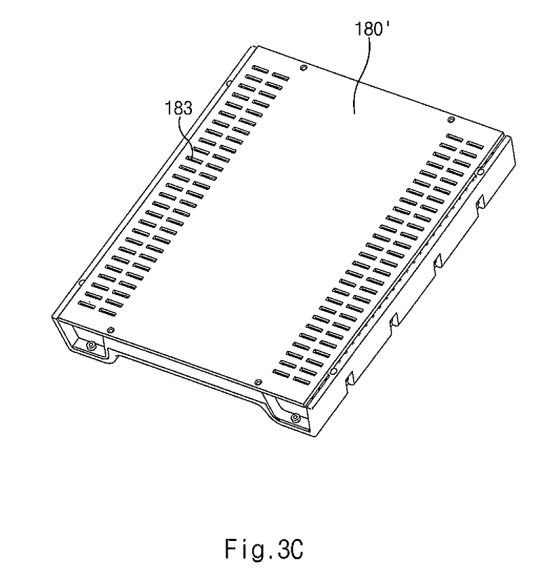

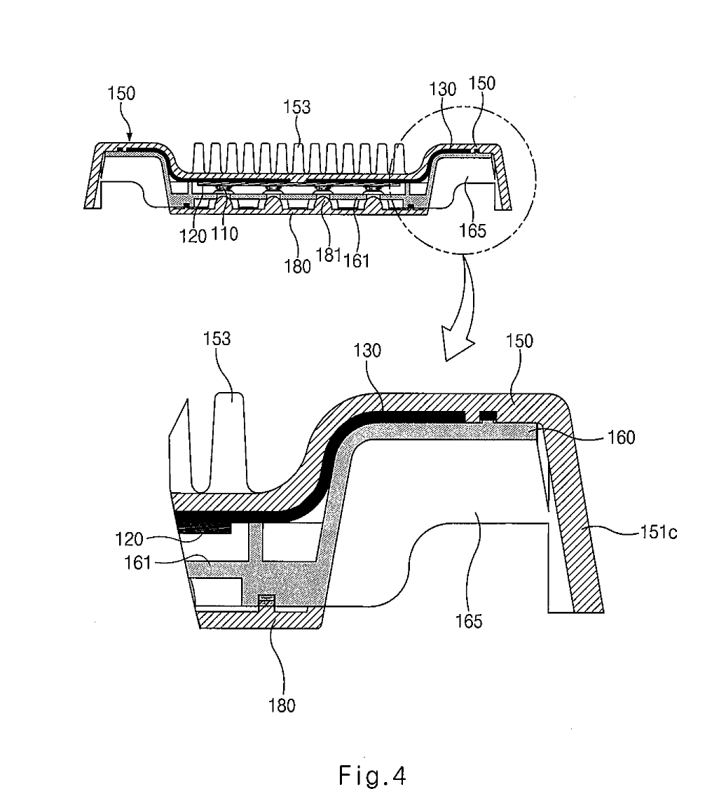

FIG. 1 is a perspective view of an LED lighting flood lamp having a double heat dissipation plate structure using nano spreaders according to an embodiment of the present invention, and FIG. 2 is an exploded perspective view of the LED lighting flood lamp illustrated in FIG. 1. FIG. 3A is a perspective view of an LED lighting flood lamp having a double heat dissipation plate structure using nano spreaders, seen from the upper part thereof, according to an embodiment of the present invention, FIG. 3B is a perspective view of an LED lighting flood lamp having a double heat dissipation plate structure using nano spreaders, seen from the lower part thereof, according to an embodiment of the present invention, and FIG. 3C is a view illustrating the LED lighting flood lamp of FIG. 3B that is used indoors. FIG. 4 is a sectional view taken along line A-A in FIG. 3A.

With reference to the above described drawings, an LED lighting flood lamp 100 having a double heat dissipation plate structure using nano spreaders according to an embodiment of the present invention includes LEDs 110, an LED mounting substrate 120 on which the LEDs 110 are mounted, nano spreaders 130 mounted on an upper side of the LED mounting substrate 120, an upper heat dissipation plate 150 fixed to an upper side of the nano 20 spreaders 130, a lower heat dissipation plate 160 fixed to a lower part of the LED mounting substrate 120, and a diffusion lens plate 180 fixed to a lower part of the lower heat dissipation plate 160.

In the above described construction, sealing members 140 and 170 (See FIG. 2) are inserted between the upper heat dissipation plate 150 and the lower heat dissipation plate 160 and between the lower heat dissipation plate 160 and the diffusion lens plate 180, respectively, to improve sealing performance.

The nano spreaders 130 are components having excellent heat transfer efficiency, and can promptly transfer the heat generated from a heat source part to another desired place.

That is, the nano spreader 130 has an outer cover formed of a copper plate and a net of a hyperfine structure (nano-sized fine net) installed inside the copper plate, in which pure H2O and steam are separately built on the basis of the hyperfine net. By the heat transferred from a heat source to an outer copper plate that is in partial contact with the heat source, inner pure H2O is converted into stream, and the converted stream dissipates heat to an outside as it moves at high speed, and then is converted into the pure H2O. By repeating the above described process, the nano spreader 130 shows the heat transfer efficiency much better than that of other products.

The technique related to the nano spreader 130 is well known in the art, and thus the detailed description thereof will be omitted.

As illustrated in the drawings, the nano spreaders 130 are mounted between the LED mounting substrate 120 that is a heat source part and the upper heat dissipation plate 150, and lower part of the nano spreader 130 is in contact with upper surface of the LED mounting substrate 120.

As illustrated in FIG. 2, the nano spreaders 130 are in the shape of a straight board, and are arranged at predetermined intervals in a length direction of the upper heat dissipation plate 150. The nano spreader 130 has a center part having a specified length, and one end of the nano spreader is bent at a specified angle to match the shape of the both ends of the upper heat dissipation plate 150.

The nano spreader 130 serves to promptly transfer the heat from the LED mounting substrate 120 to an outside of the lamp in a length direction of the nano spreader 130.

The upper heat dissipation plate 150 includes an upper heat dissipation plate housing 151 having a center part descending downward and both side parts projecting upward, and the heat dissipation pins 153 arranged on an upper surface of the center part of the upper heat dissipation plate housing 151.

As illustrated in FIG. 2, the upper heat dissipation plate housing 151 may include a center part 151a having a height lower than that of adjacent parts, and side parts 151b positioned on both sides of the center part 151a, projecting upward for a specified length, and having a reverse U-shaped (“n”) cross section. The both bent end parts 151c of the upper heat dissipation plate housing 151 are extended downward for a specified length, and fixing grooves 151d for fixing the nano spreaders 130 are formed on the lower surface of the housing 151.

On the upper portion of the center part 151a of the upper heat dissipation plate housing 151, the heat dissipation pins 153 are installed, and on the lower surfaces of the center part 151a and the side parts 151b, nano spreader fixing grooves 151d are formed.

Also, on the upper surface of the center part 151a of the upper heat dissipation plate housing 151, a series of joint parts 155 (See FIG. 3A) are formed, in addition to the heat dissipation pins 153, to facilitate connection with other constitutional members.

The nano spreader 130 has a specified length, and one end part of the nano spreader 130 is bent. Two divided nano spreaders 130 are mounted on the lower part of the upper heat dissipation plate 150 to face each other. Using the nano spreader fixing groove 151d formed on the lower part of the upper heat dissipation plate 150, the nano spreader 130 can be easily fixed to the upper heat dissipation plate 130.

The LED mounting substrate 120 is a flat plate member, and LEDs 110 are arranged at predetermined intervals on the LED mounting substrate 120.

The lower heat dissipation plate 160, as illustrated in FIGS. 2 and 4, has a structure similar to that of the upper heat dissipation plate 150 so that it can be easily fixed to the lower part of the upper heat dissipation plate 150, and includes a center part having a height lower than that of adjacent parts and both side parts projecting upward. For example, the lower heat dissipation plate 160 is composed of a flat plate member 161 having a specified thickness, on which through-holes 163 are formed at predetermined intervals, and the LEDs 110 are inserted into the through-holes 163, respectively. The both side parts of the lower heat dissipation plate 160 form auxiliary heat dissipation plates 165 for heat dissipation in a side direction. That is, both side parts of the lower heat dissipation plate 160 have the same shape as that of both side parts of the upper heat dissipation plate 165 to overlap each other. The nano spreader 130 intervenes between them.

Accordingly, the heat transferred from the LED 110 to the center portion of the nano spreader 130 is transferred up to one end part of the nano spreader 130, and then discharged to an outside through both side parts of the upper heat dissipation plate 150 and the lower heat dissipation plate 160 which are in contact with both sides of the nano spreader 130. In this case, the one end part of the nano spreader 130 is bent to have the same shape as both end parts of the upper heat dissipation plate 150 and the lower heat dissipation plate 160.

The lens diffusion plate 180 is fixed to the lower part of the lower heat dissipation plate 160, and includes a lower surface formed as a flat surface, and an upper surface on which projection members 181 (See FIG. 4) that are in contact with the LEDs 110 are formed to match the arrangement state of the LEDs 110.

The sealing member 170 is inserted between the upper heat dissipation plate 150 and the lower heat dissipation plate 160 and between the fixing parts of the lower heat dissipation plate 160 and the diffusion lens plate 180 to improve the sealing performance.

In a state where all the above described components are assembled, as illustrated in FIGS. 3A and 3B, the LED lighting flood lamp according to the present invention has a slim external appearance with a thin thickness.

FIG. 3B shows an LED lighting flood lamp 100 used outdoors, and FIG. 3C shows an LED lighting flood lamp 100 used indoors.

In the case of the LED lighting flood lamp 100 as illustrated in FIG. 3B, the auxiliary heat dissipation plates 165 formed on both sides of the lens diffusion plate 180 are exposed to an outside as they are, while in the case of the LED lighting flood lamp 100 used indoors as illustrated in FIG. 3C, the auxiliary heat dissipation plates 165 of FIG. 3B are not exposed to an outside, and thus the whole width of the lens diffusion plate 180′ is widened.

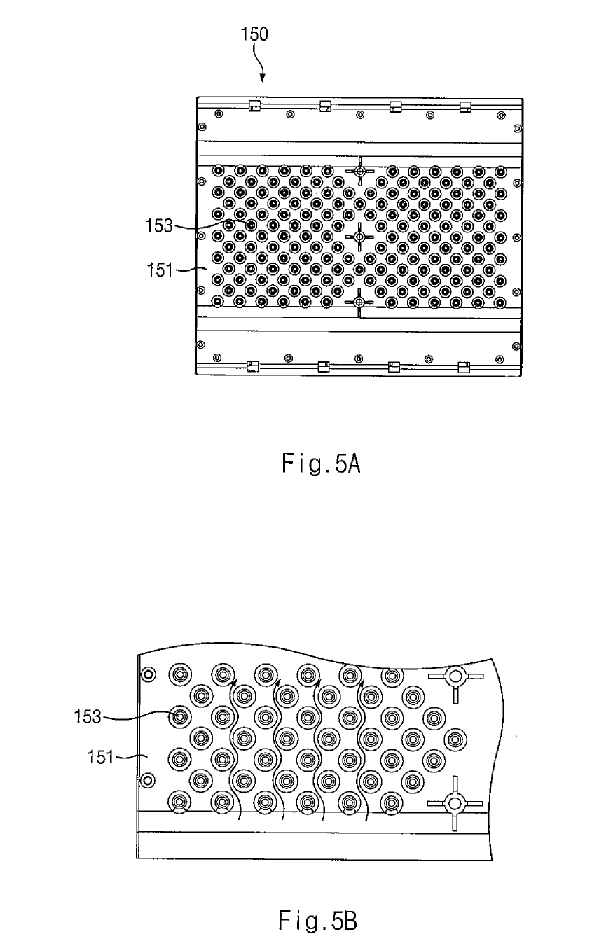

FIGS. 5A and 5B are views illustrating the plane state of the upper heat dissipation plate on which the heat dissipation pins are formed according to an embodiment of the present invention.

As illustrated in FIGS. 5A and 5B, a plurality of heat dissipation pins 153, which are installed on the upper heat dissipation plate 150, are not arranged in straight line, but are arranged in zigzag, so that air flow (indicated as arrows in the drawing) passing through the respective heat dissipation pins 153 is curved. That is, the air flow passing through the heat dissipation pins 153 is changed by the heat dissipation pins 153 arranged in zigzag, and thus dust or foreign substances are prevented from sticking to the heat dissipation pins 153. For example, in the case where the LED lighting flood lamp having the heat dissipation pins 153 arranged in zigzag is used outdoors, the foreign substances sticking to the heat dissipation plate can be easily removed through natural washing, such as a jet of water, rain, and the like.

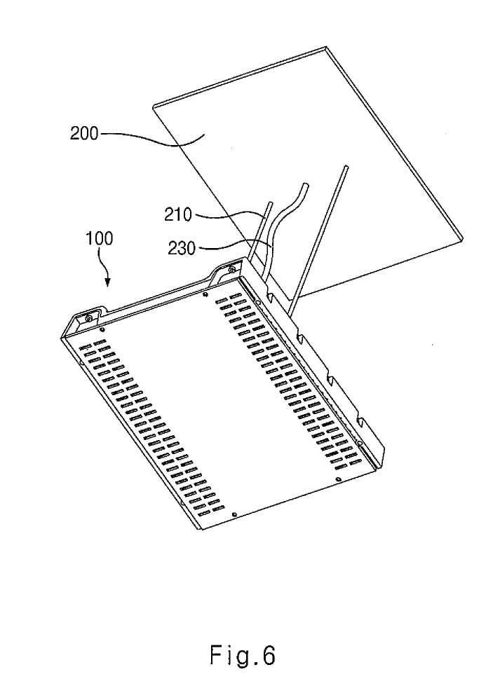

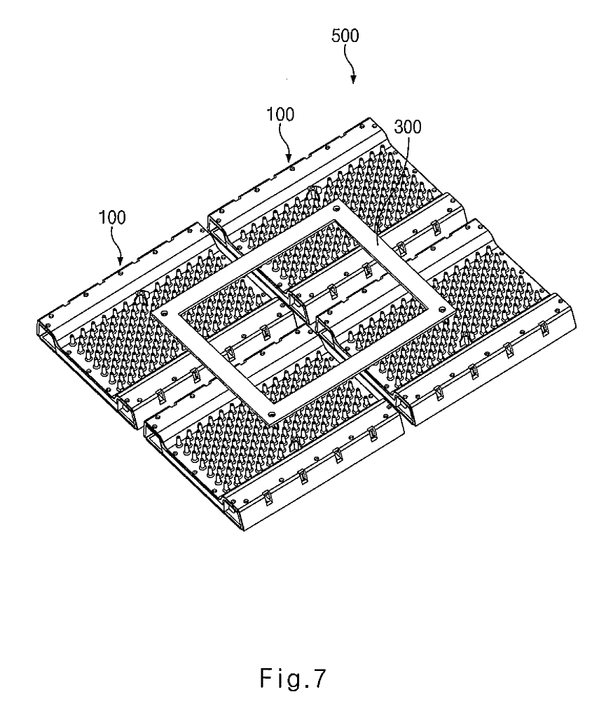

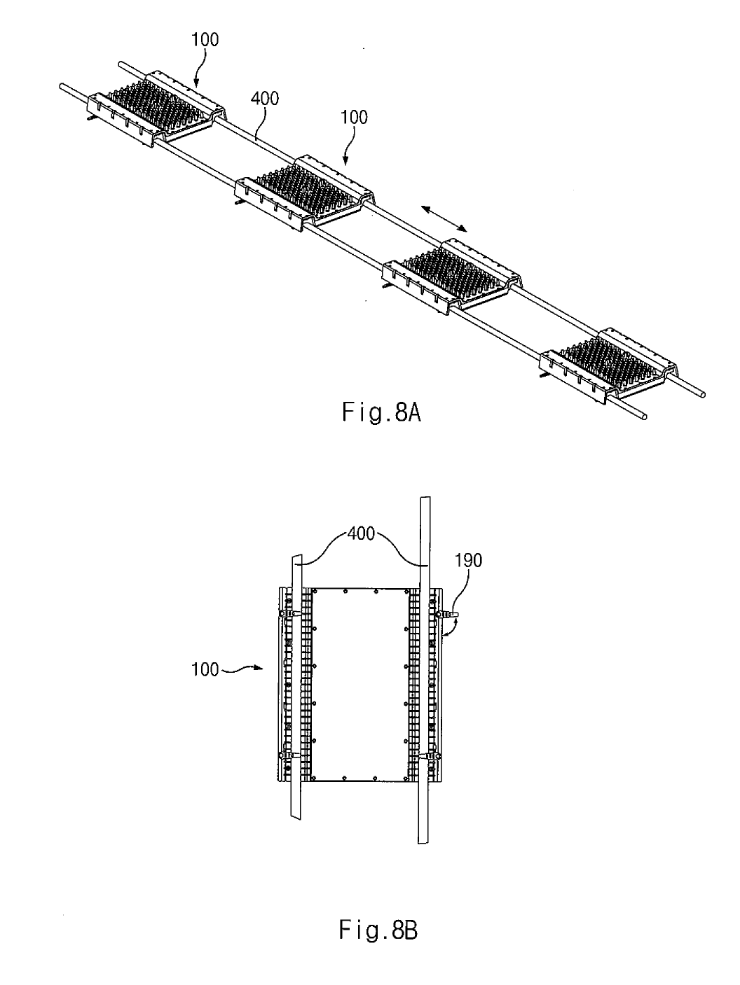

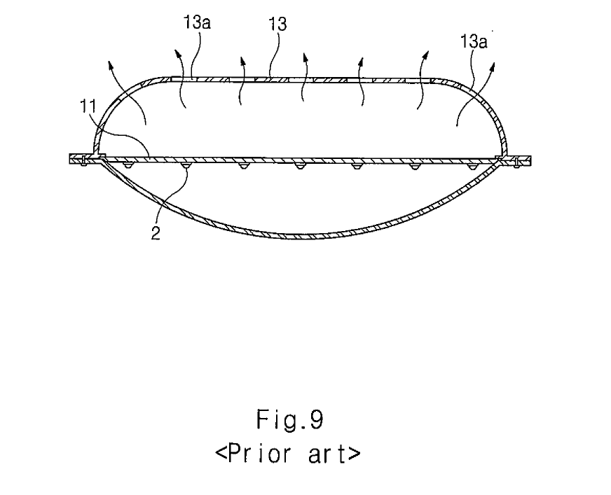

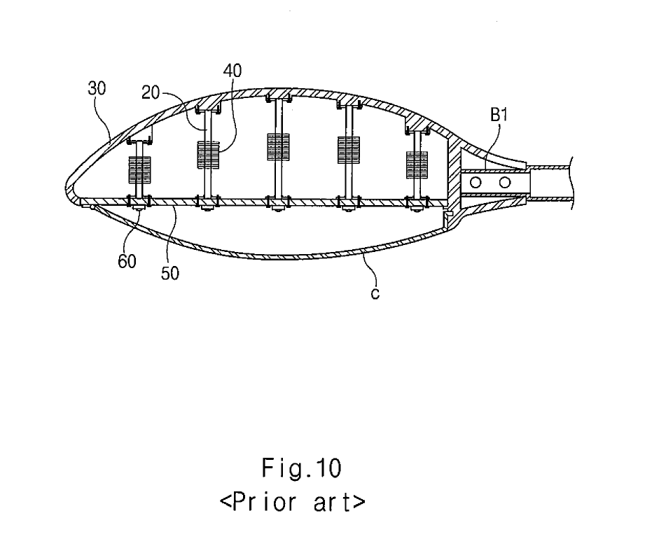

FIGS. 6 to 8A and 8B are views illustrating the use state of an LED lighting flood lamp having a double heat dissipation plate structure using nano spreaders according to an embodiment of the present invention. Specifically, FIG. 6 shows the LED lighting flood lamp used as an indoor overhead lamp, FIG. 7 shows LED lighting flood lamps combined into one, and FIGS. 8A and 8B show an LED lighting flood lamps sliding on wires according to the present invention.

Referring to FIG. 6, the LED lighting flood lamp 100 according to the present invention is installed on the ceiling 200 as an overhead lamp. The LED lighting flood lamp 100 is fixed to the ceiling using separate supports 210, and a power line 230 is electrically connected to the LED lighting flood lamp 100.

In this case, the supports 210 may be connected to the LED lighting flood lamp 100 using joint parts 155 (See FIG. 3A) provided on the upper heat dissipation plate 150 on which the heat dissipation pins 153 are formed.

Referring to FIG. 7, four LED lighting flood lamps 100 are combined. A tetragonal fixture 300 is connected to the LED lighting flood lamps using the joint parts 155 formed on the upper heat dissipation plates 150 of the respective LED lighting flood lamps, and thus the four LED lighting flood lamps 100 can be used as one LED lighting flood lamp 500. In this case, the assembled LED lighting flood lamp 500 has much larger capacity, and thus can be used as an outdoor illuminating means.

Referring to FIGS. 8A and 8B, the LED lighting flood lamp 100 is slidably connected to wires 400.

As illustrated in FIG. 8A, wires 400 pass through the lower parts of both sides of the LED lighting flood lamp 100 according to the present invention, and the LED lighting flood lamp 100 is fixed to a specified position of the wires 400 by a separate fixing means 190.

In the above described construction, the wires 400 are inserted in the lower parts of both sides of the LED lighting flood lamp 100, so that the LED lighting flood lamp 100 can slide along the wires 400. In this case, since the wires 400 cross the auxiliary heat dissipation plates 165, insertion grooves (not illustrated) passing through the auxiliary heat dissipation plates 165 are formed to receive the wires 400 therein. In order to fix the LED lighting flood lamp 100, which is slidably fastened to the wires 400, in a specified position, as illustrated in FIG. 8B, fixing means 190 are provided on both sides of the lower part of the LED lighting flood lamp 100, and the LED lighting flood lamp 100 is fixed to the wires 400 by the operation of the fixing means 190.

Accordingly, in a place where the wires 400 are installed, the LED lighting flood lamp according to an embodiment of the present invention can be movably installed, and thus can be used as an illumination fixture in various kinds of athletic stadiums for baseball game, soccer game, and the like.

That is, in the case where the illumination is required only in a specified plate, it is not required to operate all the LED lighting flood lamps, but only several requisite LED lighting flood lamps 100 are moved to the specified place along the installed wires 400 to illuminate the specified plate.

As described above, according to the LED lighting flood lamp having a double heat dissipation plate structure using nano spreaders according to the present invention, the double heat dissipation plate structure is formed by installing the nano spreaders achieving high heat diffusion inside the lamp and forming heat dissipation plates on upper and lower parts of the nano spreaders, and heat dissipation pins are arranged in zigzag on the upper part of the upper heat dissipation plate, so that the heat dissipation efficiency is maximized, and the lamp has a slim external appearance without being limited in installation space.

Also, since the LED lighting flood lamp has a compact size and good design, it can be used as not only an indoor lamp such as street lamp, security lamp, explosion proof lamp, and so on, but also an outdoor lamp for use in an outdoor athletic stadium, and so on.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An LED lighting flood lamp having a double heat dissipation plate structure using nano spreaders, comprising:
LEDs;
an LED mounting substrate on which the LEDs are mounted;
nano spreaders mounted on an upper side of the LED mounting substrate;
an upper heat dissipation plate fixed to an upper side of the nano spreaders and having a plurality of heat dissipation pins formed on an upper surface thereof;
a lower heat dissipation plate fixed to a lower part of the LED mounting substrate; and
a diffusion lens plate fixed to a lower part of the lower heat dissipation plate.

2. The LED lighting flood lamp of claim 1, further comprising sealing members inserted between the upper heat dissipation plate and the lower heat dissipation plate and between the lower heat dissipation plate and the diffusion lens plate, respectively, to improve sealing performance.

3. The LED lighting flood lamp of claim 1, wherein the nano spreaders are in the shape of a straight board, and are arranged at predetermined intervals in a length direction of the upper heat dissipation plate, and one end part of the nano spreader is extended up to side parts of the upper heat dissipation plate and the lower heat dissipation plate.

4. The LED lighting flood lamp of any one of claims 1 to 3, wherein the upper heat dissipation plate comprises an upper heat dissipation plate housing having a center part descending downward and both side parts projecting upward, and the heat dissipation pins arranged at predetermined intervals on an upper surface of the center part of the upper heat dissipation plate housing.

5. The LED lighting flood lamp of claim 4, wherein the heat dissipation pins are formed in a pin shape, and are arranged in zigzag to change air flow passing between the heat dissipation pins.

6. The LED lighting flood lamp of claim 4, wherein the upper heat dissipation plate housing is composed of a center part having a height lower than that of adjacent parts, and side parts positioned on both sides of the center part, projecting upward for a specified length, and having a reverse U-shaped (“n”) cross section.

7. The LED lighting flood lamp of claim 4, wherein the lower heat dissipation plate is composed of a center part having a flat plate member having a specified thickness, on which through-holes are formed at predetermined intervals, and both side parts projecting upward in comparison to the center part, formed to be in contact with the upper heat dissipation plate through the nano spreaders, and having auxiliary heat dissipation plates formed thereon to dissipate heat in a side direction.

8. The LED lighting flood lamp of claim 1, wherein the lens diffusion plate is composed of a lower surface formed as a flat surface, and an upper surface on which projection members that are in contact with the LEDs are formed to match the arrangement state of the LEDs.

9. The LED lighting flood lamp of claim 1, wherein the upper heat dissipation plate has connection members formed on an upper side thereof to assemble a plurality of LED lighting flood lamps into one.

10. The LED lighting flood lamp of claim 1, wherein wire insertion grooves for inserting wires therein are formed on lower portions of the side parts of an LED lighting flood lamp to move the LED lighting flood lamp along the wires, and separate wire fixing means are provided to fix the LED lighting flood lamp in a specified position of the wires.
